(19) United States
(12) Patent Application Publication
(10) Pub. No.: US 2016/0362071 A1
(43) Pub. Date: Dec. 15, 2016

(54) SEMI-INTEGRAL COVER FOR EXPOSED FASTENER

(71) Applicant: GM GLOBAL TECHNOLOGY OPERATIONS LLC, Detroit, MI (US)

(72) Inventors: James R. Roll, Ann Arbor, MI (US); Thomas L. Loeffler, Almont, MI (US)

(21) Appl. No.: 14/734,457

(22) Filed: Jun. 9, 2015

(51) Int. Cl. B60R 13/02; F16B 37/14

(52) U.S. Cl. CPC B60R 13/0243; F16B 37/14

(57) ABSTRACT

A multi-part fastener cover comprises an attachment insert having a plate that is over-moldable into a component, with an axially extending annular attachment ring and a retainer ledge extending from a side thereof, that extends about a through-bore for receiving a fastener. A closure comprises an outwardly facing surface having a retainer that extends from an inner surface opposite the outwardly facing surface, wherein the retainer is configured to engage the retainer ledge extending from the side of the axially extending annular attachment ring of the plate to thereby move with the component.

### FIELD OF THE INVENTION

The subject of the invention is related to covers for exposed fasteners and, more particularly, to a semi-integral cover that is partially integral with an insert in a molding thereby minimizing variation to the edges and improving the appearance of the molding when installed.

### BACKGROUND

Automotive design and assembly must take into account safety, durability, appearance and styling. Various assemblies may comprise multiple components that are held together with various fasteners. A common fastener is a bolt that threads into a corresponding opening and may align several parts. It is important, especially from a customer satisfaction perspective, that the fasteners properly align and hold the multiple components together through the life of the vehicle, not add to vehicle Noise, Vibration or Harshness (NVH) and, create an atheistically pleasing appearance.

Vehicle door assemblies are particularly vulnerable to the above concerns. Door assemblies comprise multiple components and structures that are not entirely supported by the vehicle body structure (i.e. they must open outwardly supported on hinges). In addition the door assemblies must, when closed, properly seal against air leaks, moisture and noise. A common door assembly technique is referred to as Frame-Under-Glass (FUG) assembly, which benefits from a fastening assembly near the upper B-Pillar to secure and align several components. This portion of the door assembly is exposed to view when the vehicle door is open and is subject to repeated door slams over the vehicle life. It is of particular concern that the fastener used in this location be durable and attractive. To date, many fasteners used in this application have had an unsightly appearance or have lacked the requisite durability.

### SUMMARY OF THE INVENTION

In an exemplary embodiment a multi-part fastener cover comprises an attachment insert comprising a plate, over-moldable into a component, having an axially extending annular attachment ring with a retainer ledge extending from a side thereof, extending about a through-bore for receiving a fastener. A closure comprises an outwardly facing surface having a retainer that extends from an inner surface opposite the outwardly facing surface, wherein the retainer is configured to engage the retainer ledge extending from the side of the axially extending annular attachment ring of the plate to thereby move with the component.

In another exemplary embodiment, a vehicle assembly comprises a door frame having a fastener opening, a molding assembly and an attachment insert comprising a plate, over-moldable into the molding assembly, and having an axially extending annular attachment ring with a retainer ledge extending from a side thereof that extends about a through-bore for receiving a fastener. A fastener extends into the through-bore and the fastener opening to engage the door assembly with the molding assembly. A closure comprises a decorative, outwardly facing surface having a retainer that extends from an inner surface opposite the decorative, outwardly facing surface and configured to engage the retainer ledge extending from the side of the axially extending annular attachment ring of the plate to thereby cover the fastener and to move with the molding assembly.

The above features and advantages, and other features and advantages of the invention, are readily apparent from the following detailed description of the invention when taken in connection with the accompanying drawings.

### BRIEF DESCRIPTION OF THE DRAWINGS

Other features, advantages and details appear, by way of examples only, in the following detailed description of the embodiments, the detailed description referring to the drawings in which:

FIG. 1 is a partial perspective view of an inner door assembly illustrating features of the invention;

FIG. 2 is a plan view of the partial door assembly of FIG. 1, with parts removed and partly shown in phantom; and

FIG. 3 is a cross-sectional view of FIG. 1 taken along Line 3-3.

### DESCRIPTION OF THE EMBODIMENTS

The following description is merely exemplary in nature and is not intended to limit the present disclosure, its application or use. It should be understood that throughout the drawings, corresponding reference numerals indicate like or corresponding parts and features. As used herein the term vehicle is not limited to just an automobile, truck van or sport utility vehicle, but includes any self-propelled or towed conveyance suitable for transporting a burden.

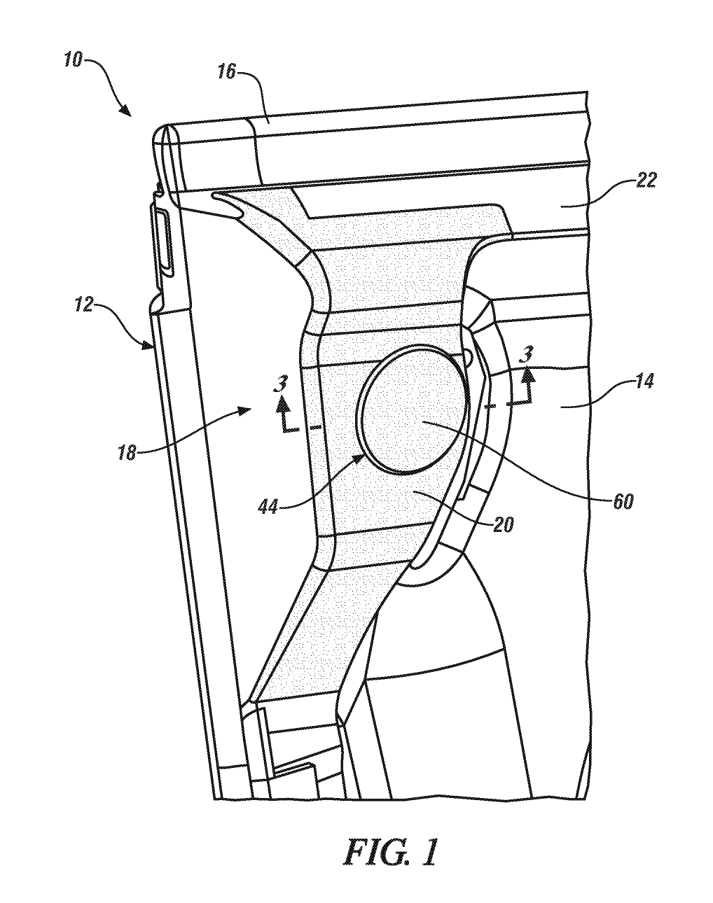

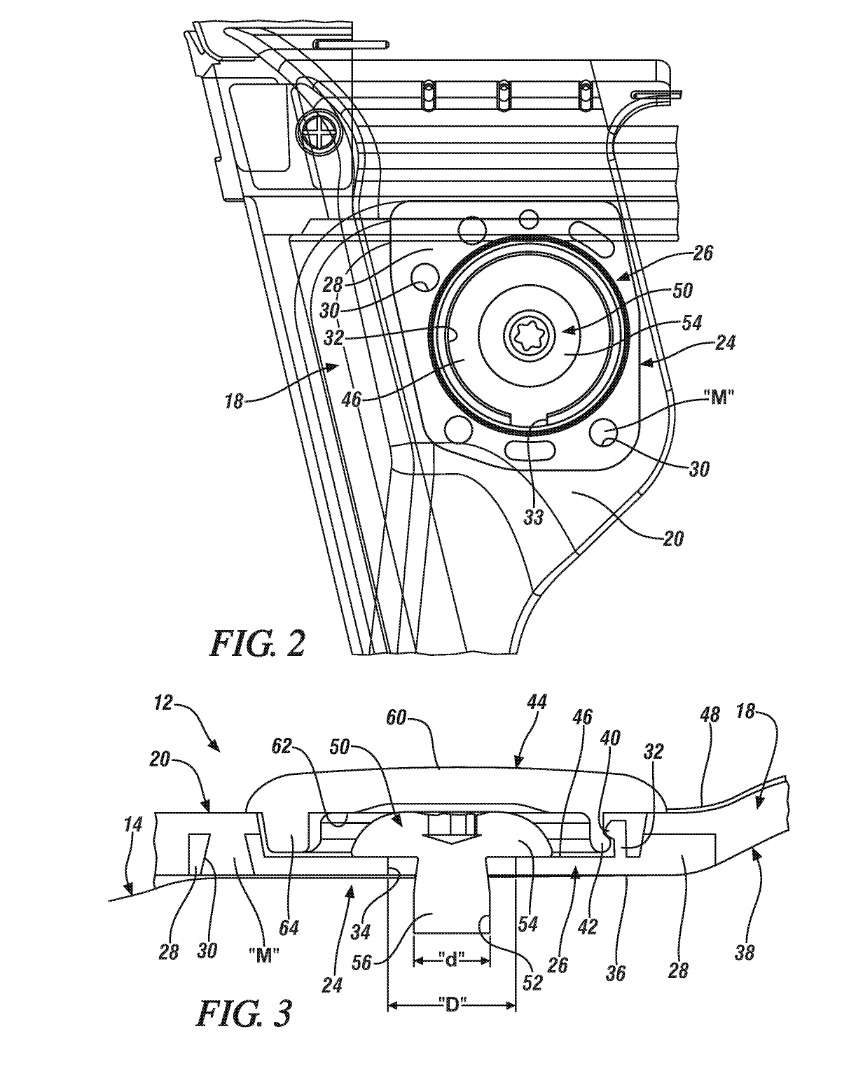

Referring now to FIG. 1, in an exemplary embodiment, a vehicle assembly 10 is illustrated in which the assembly is, for purposes of description only, a door assembly 12. The door assembly 12 comprises an inner door frame or structure 14 an outer door frame or structure 16 and a component such as a molding assembly 18 that encloses a portion of the two structures 14 and 16, respectively. The inner door frame 14 and outer door frame may be welded together to provide an underlying structure for the door assembly 12, to which other components such as window regulators, locks switches, trim and the molding assembly 18 are attached. Referring to FIGS. 2 and 3, with continuing reference to FIG. 1, the molding assembly 18 may comprise a combination of trim portions 20 and seal portions 22 that are formed into a single component for attachment to the door assembly 12. An attachment insert 24 comprises a plate 26 having an anchor portion 28 which may, in an exemplary embodiment include staking through-bores 30, to be described in further detail herein. An axially extending annular attachment ring 32 surrounds a through-bore 34 located centrally of the plate 26 and an optional anti-rotation slot 33 may be located in the annular attachment ring also to be described in further detail herein. The retention ring 32 may include a retainer ledge 40 that extends from a side thereof and is configured to engage a corresponding retainer 42 of a cap or closure 44 that is placed over the axially extending annular attachment ring 32 following assembly of the door 12.

The attachment insert 24 is, in an embodiment, over-molded into the molding assembly 18 during its manufacture such that the bottom 36 of the plate 26 faces outwardly from the inner surface 38 of the molding assembly 18 and material “M” used to construct the molding assembly flows into the staking through-bores 30 to assure retention of the attachment insert in the molding assembly 18. The top 46 of the plate 26 inwardly of the axially extending annular attachment ring 32 faces outwardly from the outer surface 48 of the molding assembly 18 such that the through bore 34 may accept a threaded bolt 50 or other suitable fastener therein. The threaded bolt 50, in the embodiment illustrated, engages the door inner frame 14 with the molding assembly 18. As the bolt 50 threads into an opening 52 in the inner door frame 14 the head 54 of the bolt engages the top 46 of the plate 26 to thereby draw the molding assembly 18 together tightly thereagainst. The through-bore 34 diameter “D” may be larger than the diameter “d” of the opening 52 and corresponding bolt shaft 56 to allow for some averaging or play when positioning the molding assembly 18 thereby assuring a quality fit and finish.

The cap or closure 44 may comprise a decorative, outwardly or customer facing surface 60. The surface 60 may comprise any suitable shape, color and texture that is suitable for the location and surrounding material. The retainer 42 extends from the surface opposite the customer facing surface 60, or the inner surface 62. The retainer 42 is configured to engage the retainer ledge 40 that extends from the side of the axially extending annular attachment ring 32 of the plate 26. The retainer 42 may comprise a corresponding annular ring having a similar but opposite facing retainer ledge or, in an embodiment may comprise a series of individual hook shaped elements that extend from the inner surface 62 that are also configured to engage the retainer ledge 40. Other configurations are also envisioned. An anti-rotation protrusion 64 may extend outwardly from the inner surface 62 of the closure 44 and engages the anti-rotation slot 33 that may be located in the annular attachment ring 32 to properly position the closure with respect to the molding assembly 18 and to prevent any movement relative thereto.

The semi-integral cover assembly described herein provides a novel and aesthetically pleasing cover for an otherwise exposed fastener. The cover assembly is packageable in a minimal space, prevent distortion of the molding assembly under the torque of the fastener due to the integration of the attachment insert therein and provides a consistent appearance since the closure attaches and moves with the mold assembly and does not attach directly to the inner or outer door frame assemblies. While the invention has been described with reference to exemplary embodiments, it will be understood by those skilled in the art that various changes may be made and equivalents may be substituted for elements thereof without departing from the scope of the invention. In addition, many modifications may be made to adapt a particular situation of material to the teachings of the invention without departing from the essential scope thereof. Therefore, it is intended that the invention not be limited to the particular embodiments disclosed, but that the invention will include all embodiments falling within the scope of the application.

1. A multi-part fastener cover comprising:
an attachment insert comprising a plate, over-moldable into a component, the attachment insert having an axially extending annular attachment ring including a retainer ledge extending radially inwardly from a side thereof, the retainer ledge extending about a through-bore for receiving a fastener; and
a closure comprising an outwardly facing surface, and an inner surface opposite the outwardly facing surface, the closure including a retainer that extends from the inner surface, wherein the retainer is configured to engage the retainer ledge extending from the side of the axially extending annular attachment ring of the plate to thereby move with the component.

2. The multi-part fastener cover of claim 1, the plate further comprising an anchor portion include staking through-bores configured to receive material used to construct the component.

3. The multi-part fastener cover of claim 1, the axially extending annular attachment ring further comprising an anti-rotation slot configured to engage an anti-rotation protrusion extending from the inner surface of the closure to position the closure with respect to the component and to prevent movement relative thereto.

4. The multi-part fastener cover of claim 1, the retainer of the closure comprising an annular ring having a corresponding retainer ledge engageable with the retainer ledge of the axially extending annular attachment ring extending from the plate.

5. The multi-part fastener cover of claim 1, the retainer of the closure comprising a series of individual hook elements engageable with the retainer ledge of the axially extending annular attachment ring extending from the plate.

6. The multi-part fastener cover of claim 1, the outwardly facing surface of the closure comprising a shape, color and texture that is suitable for the location and surrounding material of the component.

7. The multi-part fastener cover of claim 1, wherein the component comprises a molding assembly applied to a door assembly of a vehicle assembly.

8. A vehicle assembly comprising:
a door frame having a fastener opening;
a molding assembly;
an attachment insert comprising a plate, over-moldable into the molding assembly, the attachment insert having an axially extending annular attachment ring including a retainer ledge extending from a side thereof that extends about a through-bore;
a fastener extending into the through-bore and the fastener opening to engage the door frame with the molding assembly; and
a closure comprising a decorative, outwardly facing surface and an inner surface opposite to the outwardly facing surface, the closure including a retainer that extends radially inwardly from the inner surface, the retainer being configured to engage the retainer ledge extending from the side of the axially extending annular attachment ring of the plate to thereby cover the fastener and to move with the molding assembly.

9. The vehicle assembly of claim 8, the plate further comprising an anchor portion including staking through-bores configured to receive material used to construct the molding assembly.

10. The vehicle assembly of claim 8, the axially extending annular attachment ring further comprising an anti-rotation slot configured to engage an anti-rotation protrusion extending from the inner surface of the closure to position the closure with respect to the molding assembly and to prevent movement relative thereto.

11. The vehicle assembly of claim 8, the retainer of the closure comprising an annular ring having a corresponding retainer ledge engageable with the retainer ledge of the axially extending annular attachment ring extending from the plate.

12. The vehicle assembly of claim 8, the retainer of the closure comprising a series of individual hook shaped elements engageable with the retainer ledge of the axially extending annular attachment ring extending from the plate.

13. The vehicle assembly of claim 8, the decorative, outwardly facing surface of the closure comprising a shape, color and texture that is suitable for the location and surrounding material of the molding assembly.
